(19) United States
(12) Patent Application Publication
(10) Pub. No.: US 2005/0057918 A1
(43) Pub. Date: Mar. 17, 2005

(54) Illumination device for a roller skate

(76) Inventor: Ting-Hsing Chen, Tainan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/660,505

(22) Filed: Sep. 12, 2003

(51) Int. Cl. F21V 21/08

(52) U.S. Cl. 362/103

(57) ABSTRACT

An illumination device for a roller skate includes a base unit, a generator unit, rollers, fasteners and tubes. A pair of conducting plates are secured to the base unit and connected with the generator unit. Each of the fasteners comprises a sleeve and a bolt. Each of the rollers includes an insulating sleeve having a pair of shafts at respective ends. Each roller further includes an illumination element with two electric wires connecting with the two shafts. The sleeve of each fastener is inserted through the tube and the insulating sleeve, and is secured to the base unit by the bolt. The tube is connected with one of the shafts whereas the two conducting plates are connected with the other shaft of the roller and the bolt of the fastener.

### FIELD OF THE INVENTION

This invention relates to a roller skate, and more particularly to a roller skate with an illumination device.

### BACKGROUND OF THE INVENTION

Roller skates are popular in all communities due to its convenient and time saving. However, the products currently on the market can only roll without any other designs, which are tedious and less attractive. A new design was later derived, which places an illumination device on each wheel with a generator formed by a coil and a magnet thereon. When the skate is rolling, the generator activates the illumination device, which is more attractive than previous designs. But this design also has shortcomings, one of which is that the production cost is higher, which reduces the compatibility of the product on the market.

### SUMMARY OF THE INVENTION

It is the primary object of the present invention to provide an illumination device for a roller skate, which is cost effectiveness in manufacture.

It is another object of the present invention to provide an illumination device for a roller skate, which is more attractive.

It is a further object of the present invention to provide an illumination device for a roller skate, which is easy to maintain.

### BRIEF DESCRIPTION OF THE DRAWINGS

FIG. 1 is a side view of a roller skate incorporated with the present invention;

FIG. 2 is a cross sectional view taken along line A-A of FIG. 1;

FIG. 3 is a cross sectional view taken along line B-B of FIG. 1;

FIG. 4 is a cross sectional view of a second embodiment of the present invention; and

FIG. 5 is a side view of a third embodiment of the present invention.

### DETAILED DESCRIPTION OF THE PREFERRED EMBODIMENTS

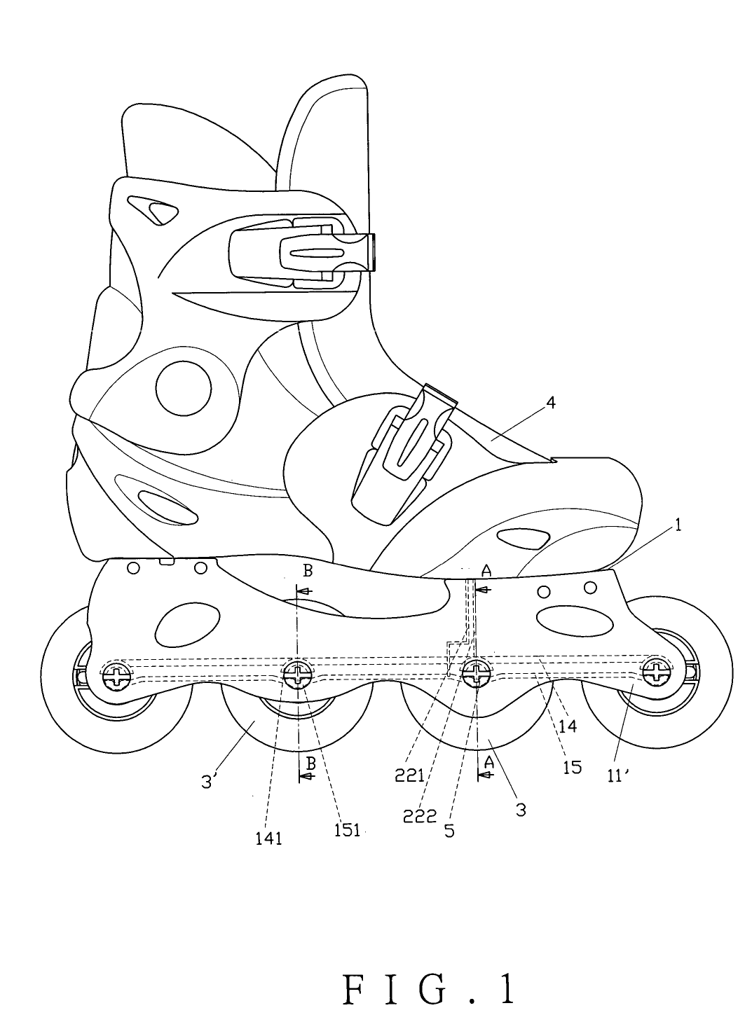

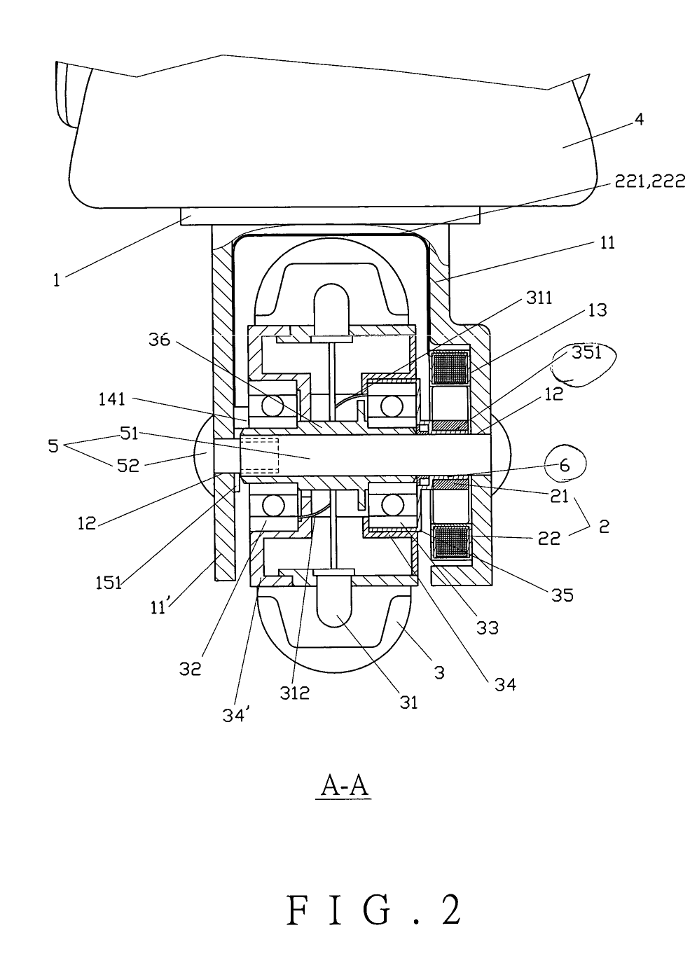

As shown in FIGS. 1 and 2, the present invention comprises a base unit 1, a generator unit 2, rollers 3 and 3′, fasteners 5 and a tube 6. Each of the fasteners 5 includes a sleeve 51 and a bolt 52. Both of which are made of conductive material and are used to secure rollers 3 and 3′ to conduct electricity. The tube 6 is a T-shaped conductive tube.

The base unit 1 is secured under a shoe 4, having a pair of fixtures 11 and 11′ extending downwardly from both sides. Each of the fixtures 11 and 11′ has a plurality of holes 12 equally spaced from each other. One fixture 11 is formed with a recess 13 corresponding to the respective hole 12 for accommodating the generator unit 2 therein. The generator unit 2 may either be composed of a magnet ring 21 and a coil 22 or a battery to seat therein. The other fixture 11′ has a pair of electric wires 221 and 222 corresponding to the coil 22 of the generator unit 2, and a pair of conducting plates 14 and 15 connecting with the electric wires 221 and 222. The conducting plates 14 and 15 are provided with a number of conducting rims 141 and 151 facing every hole 12.

Each of the rollers 3 and 3′ is incorporated with an illumination element 31 and equipped with an insulating sleeve 36 axially. A pair of shafts 32 and 33 are formed at respective sides of the insulating sleeve 36. The illumination element 31 comprises a pair of electric wires 311 and 312 connecting with the shafts 32 and 33, respectively. Each of the rollers 3 and 3′ is set with wheel covers 34 and 34′ for the shafts 32 and 33 at respective sides. The roller 3 is secured with a cover 35 at one side. The cover 35 comprises a hollow axle tube 351. The tube 6 is located in the cover 35 for connecting with the shaft 33 and the sleeve 51.

To assemble the present invention, place the generator unit 2 in the recess 13 of the base unit 1 with the electric wire 221 and 222 connected with the conducting plates 14 and 15 of the fixture 11′, then place the rollers 3 and 3′ into the two fixtures 11, 11′, and then insert the sleeve 51 of the fastener 5 through the axle tube 351 of the cover 35, and then through the insulating sleeve 36 and secured with the bolt 52 at the other end. The rollers 3, 3′ are coupled to the fixtures 11, 11′ securely.

The axle tube 351 of the cover 35 of the roller 3 is inserted through the magnetic ring 21 of the generator unit 2 whereas the conducting plates 14 and 15 of the fixtures 11, 11′ are connected with the shaft 32 and the bolt 52 through the conducting rims 141 and 151. Due to the bolt 52 and the sleeve 51 are threaded together, and the sleeve 51 and the tube 6 are connected with the shaft 33 of the roller 3, thus electricity power from the generator unit 2 are transferred to activate the illumination element 31 by the conductive rims 14 and 15, the sleeve 51, the bolt 52 and the shafts 32 and 33.

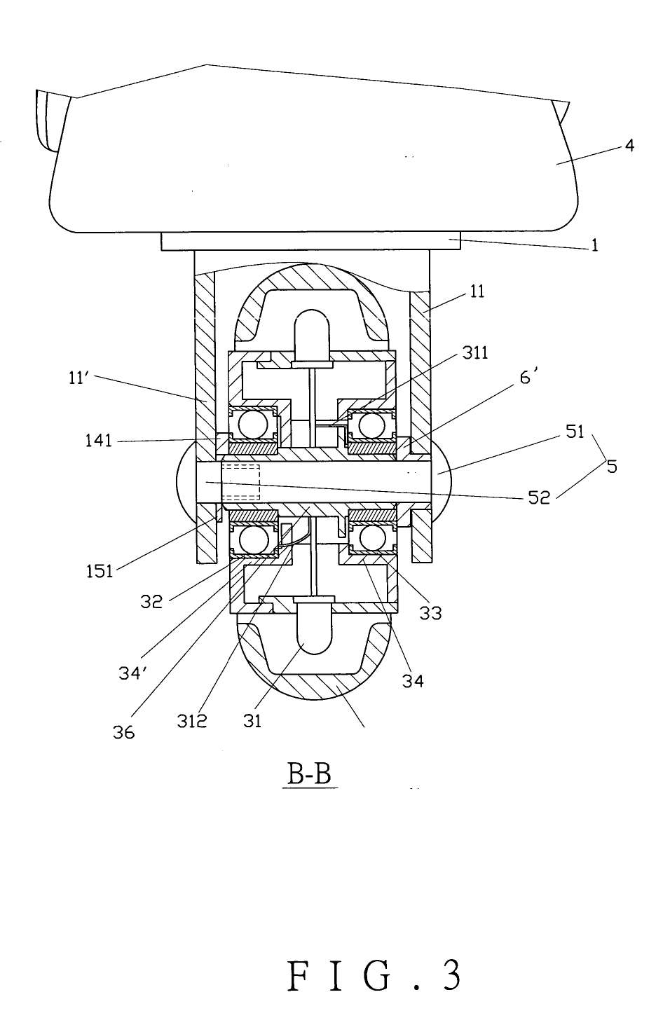

The rollers 3′ are also conducted through the conducting rims 141 and 151 of the conducting plates 14 and 15 with the bolts 52 and the shafts 32, as shown in FIGS. 1 and 3. One side of each roller 3′ is in touch with a metal tube 6′ connected with the sleeve 51. The metal tube 6′ is in touch with the shaft 33 to transfer electricity power to the shaft 33, thus the electric wires 311 and 312 within the illumination element 31 are activated.

When the roller skate is moving, the magnet ring 21 of the generator unit 2 rotates with the cover 35 with respect to the coil 22 to produce electricity which is transferred through the electric wires 221 and 222 to the conducting plates 14 and 15 of the fixture 11′, the electricity power is then transferred through the shaft 32 and the bolt 52 of each roller 3 and 3′, and to each illumination element 31. The generator unit 2 illuminates all illumination elements 31 in the rollers 3 and 3′.

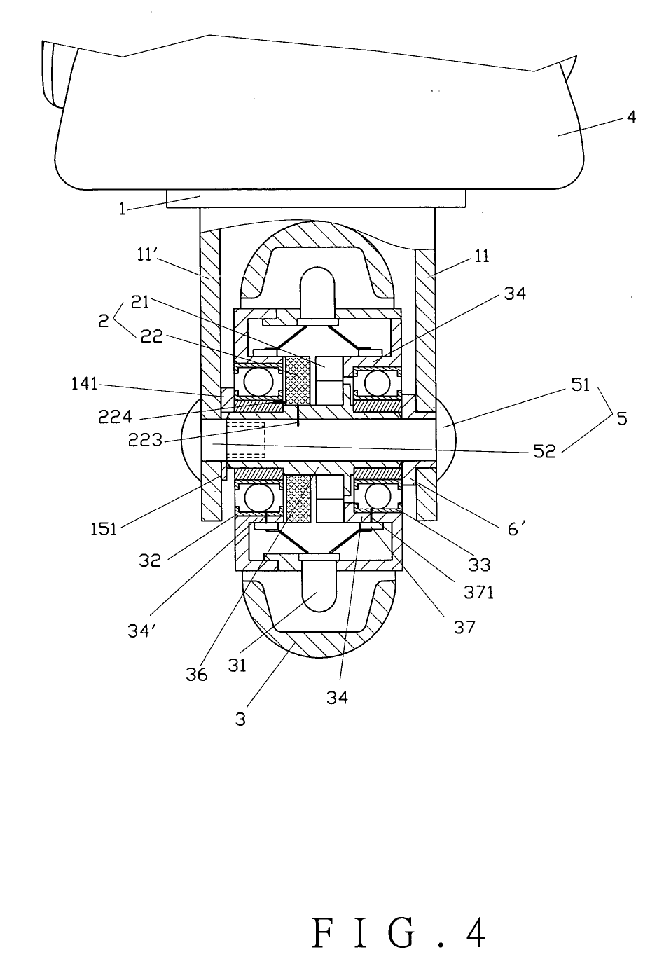

Further, the generator unit 2 may be installed within the roller 3, as shown in FIGS. 1 and 4. This design is to secure the magnet ring 21 of the generator unit 2 on the wheel cover 34 of the roller 3, and the coil 22 is secured on the insulating sleeve 36 of the sleeve 51 with two electric wires 223 and 224 connecting to the sleeve 51 and the shaft 32. The illumination element 31 has its two feet connected with a copper ring 37, which in turn is connected with outer rings of the shafts 32 and 33 through an electric wire 371. When the shafts 32 and 33 rotate, the electricity is produced to activate the illumination elements 31.

When rotating, the magnet ring 21 on the roller 3 rotates with respect to the coil 22 to generate electricity, which then is transferred through the electric wires 223 and 224 of the coil 22 to the shaft 32 and the sleeve 51. Due to the shaft 32 and the sleeve 51 are in touch with the conducting rims 141 and 151 of the conducting plates 14 and 15, electricity transfers through the conducting plates 14 and 15 to activate the illumination elements 31.

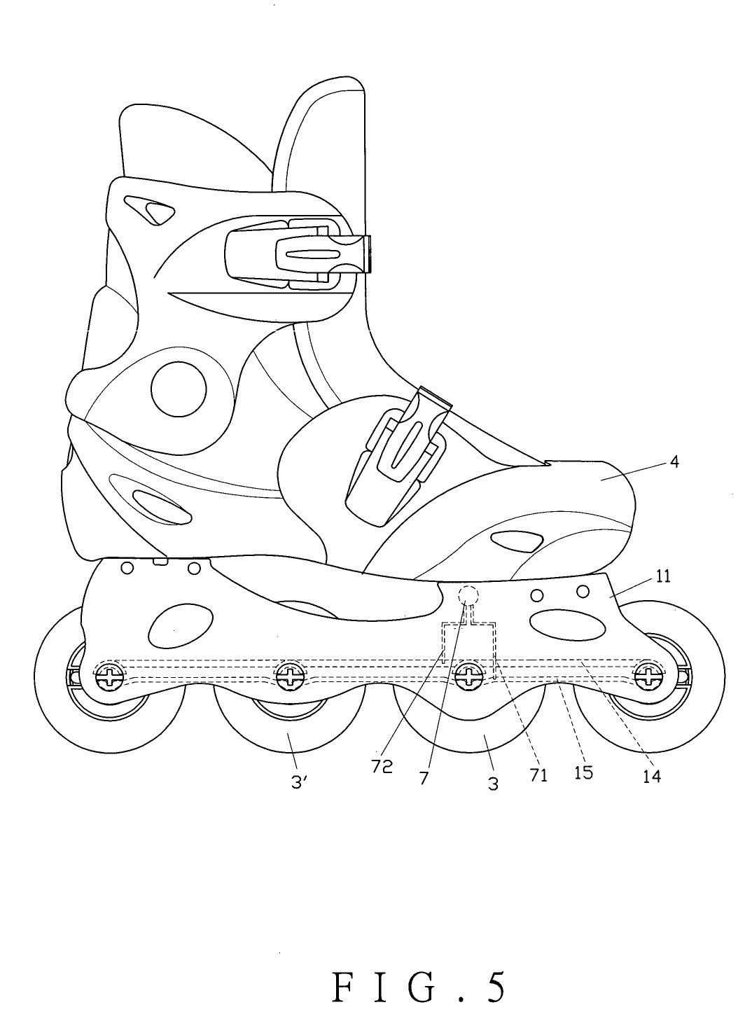

The generator unit 2 of this invention may be in other way, such as FIG. 5, which shows the generator unit 2 is replaced with a battery 7 secured on the fixture 11. The battery 7 is provided with two electric wires 71 and 72 connecting with the conducting plates 14 and 15, through which to transfer the electricity to the rollers 3 and 3′ to activate the illumination elements 31.

1. An illumination device for a roller skate comprising a base unit, a generator unit, rollers, tubes and fasteners, said base unit comprising a pair of fixtures extending downwardly from two sides thereof, said generator unit comprising a pair of electric wires, said rollers being coupled to said base unit between said fixtures by said fasteners, each said tube being conductive and being secured to one side of each said roller, said fasteners being conductive and each comprising a sleeve and a bolt;
said base unit further comprising a pair of conducting plates to be connected with said electric wires of said generator unit;
each said roller comprising an insulating sleeve at a center thereof, said insulating sleeve comprising a pair of shafts at respective sides thereof, each said roller further comprising an illumination element, said illumination element comprising a pair of electric wires connecting with said shafts of said insulating sleeve, respectively;
each said tube being engaged with one of said shafts of each said roller and being inserted by said sleeve of said fastener, which then inserting through said insulating sleeve of said roller, and then secured by said bolt thereat, whereas said conducting plates of said base unit being connected with the other said shaft of said roller and said bolt of said fastener to transfer electricity.

2. The illumination device for a roller skate, as recited in claim 1, wherein one of said rollers comprises a cover at one side thereof, said cover being adapted to accommodate said generator unit therein, and said electric wires connected with said conducting plates of said base unit.

3. The illumination device for a roller skate, as recited in claim 1, wherein said generator unit is secured within said roller, and said two electric wires of said generator unit are connected with said shafts of said roller.

4. The illumination device for a roller skate, as recited in claim 1, wherein said generator unit is secured to said base unit with said two electric wires connecting with said conducting plates.
